(19) United States
(12) Patent Application Publication
(10) Pub. No.: US 2016/0262218 A1
(43) Pub. Date: Sep. 8, 2016

(54) HIGH-FREQUENCY INDUCTION MELTING FURNACE

(71) Applicant: KITASHIBA ELECTRIC CO., LTD., Fukushima-shi, Fukushima (JP)

(72) Inventor: Hironori Tanaka, Fukushima-shi, Fukushima (JP)

(21) Appl. No.: 14/396,674

(22) PCT Filed: Jul. 14, 2014
(86) PCT No.: PCT/JP2014/068702

§ 371 Date: Oct. 23, 2014

(30) Foreign Application Priority Data
Sep. 5, 2013 (JP) 2013-183673

(51) Int. Cl. H05B 6/24; H05B 6/40

(52) U.S. Cl. CPC H05B 6/24; H05B 6/40

(57) ABSTRACT

Provided is a high-frequency induction melting furnace which decreases a loss along a total length of a coil, so that a heating efficiency can further be improved. An energization coil 3 is wound around an outer periphery of a melting chamber 2 so that tube body spaces a, b of both end portion regions H, L having predetermined numbers of turns from feeding terminals 33, 34, respectively, are larger than a tube body space c of an central portion region S positioned between the both end portion regions H and L. A tube body 32 constituting the energization coil 3 is formed so that in a cross section perpendicular to an axial line of a longitudinal direction of the tube body, an outer peripheral shape and an inner peripheral shape which is a water flow path 31 are both rectangular.

### TECHNICAL FIELD

The present invention relates to a high-frequency induction melting furnace which supplies a power to an energization coil wound around an outer periphery of a melting chamber to melt a material to be heated in the melting chamber.

### BACKGROUND ART

In general, this type of high-frequency induction melting furnace comprises an energization coil wound around an outer periphery of a melting chamber and a cooling coil wound around the outer periphery of the melting chamber positioned above the energization coil.

Feeding terminals are disposed at upper and lower ends of the energization coil, and a power required for a heating function is supplied from both of the feeding terminals to the energization coil.

Each of the energization coil and the cooling coil is formed by a longitudinal tube body, and its inside is used as a water flow path through which cooling water flows.

When a material to be heated such as cast steel or the like is thrown into the melting chamber and when the energization coil is energized by an AC power source connected to the feeding terminals, an alternating magnetic field is generated in the energization coil. When this alternating magnetic field interlinks with the material to be heated, an induced current flows in the material to be heated. Furthermore, Joule heat is generated by this induced current and a resistance of the material to be heated itself, whereby the material to be heated melts.

Additionally, in the energization coil, the magnetic flux is bent toward the material to be heated in the vicinities of the upper and lower ends, and hence the magnetic flux crosses the coil. Therefore, an eddy current loss which heats the energization coil itself is generated. Furthermore, when the tube body is wound around the outer periphery of the melting chamber at the same pitch (i.e., so that tube body spaces made in an upward-downward direction become equal) to form the energization coil, the eddy current losses in the vicinities of both feeding terminals excessively enlarge, and a heating efficiency with respect to the material to be heated deteriorates.

To solve the problem, the present applicant has first suggested a constitution where a tube body space of an end portion region having the predetermined number of turns from each feeding terminal of the energization coil is larger than a tube body space of a central portion region positioned between the both end portion regions (see Patent Literature 1 described in the following). According to this constitution, in the vicinities of the both feeding terminals, the tube body space is large, and hence less magnetic flux crosses the energization coil. Therefore, the eddy current losses decrease, so that the heating efficiency with respect to the material to be heated can be improved.

### CITATION LIST

### Patent Literature

Patent Literature 1: Japanese Patent Application Laid-Open No. S57-46489

### SUMMARY OF INVENTION

### Technical Problem

However, in this type of high-frequency induction melting furnace, even when there is employed an energization coil in which a tube body space in the vicinity of each feeding terminal is larger than a tube body space of a central portion region, an electric loss in the vicinity of the both feeding terminals is merely decreased, and hence a further higher efficiency has been required.

In view of the above respect, an object of the present invention is to provide a high-frequency induction melting furnace in which a loss along a total length of a coil is decreased, so that heating efficiency can further be improved.

### Solution to Problem

To achieve such an object, according to the present invention, there is provided a high-frequency induction melting furnace comprising an energization coil formed by winding a longitudinal tube body having therein a water flow path through which cooling water flows, around an outer periphery of a melting chamber, and including feeding terminals disposed at upper and lower ends of a height direction; and a cooling coil formed by winding another longitudinal tube body having therein a water flow path through which the cooling water flows, around the outer periphery of the melting chamber which is positioned above the energization coil, to melt a material to be heated in the melting chamber by a power supplied from a high-frequency power source to the energization coil via the upper and lower feeding terminals, wherein in the energization coil, a tube body space of an end portion region having a predetermined number of turns from each of the feeding terminals is larger than a tube body space of a central portion region positioned between the both end portion regions, and a high-frequency current of 300 Hz to 10 kHz is supplied from the high-frequency power source to the energization coil via the feeding terminals, the tube body constituting the energization coil is made of copper, and is formed so that in a cross section perpendicular to an axial line of a longitudinal direction along a total length of the tube body, an outer peripheral shape and an inner peripheral shape which is the water flow path are both rectangular and four sides have an equal thickness, and the tube body constituting the cooling coil is made of austenitic stainless steel.

In the present invention, there is employed the energization coil in which the tube body space of the end portion region having the predetermined number of the turns from each feeding terminal is larger than the tube body space of the central portion region positioned between the both end portion regions. In consequence, a magnetic flux crossing the energization coil in the vicinity of each of the both feeding terminals is decreased, and an eddy current loss is decreased, so that heating efficiency with respect to the material to be heated can be improved.

Furthermore, in the present invention, the above energization coil is constituted by using the tube body formed so that in the cross section perpendicular to the axial line of the longitudinal direction, the outer peripheral shape and the inner peripheral shape which is the water flow path are both rectangular. In consequence, when the same number of the turns and the same winding space are used, a surface area of the tube body whose cross section is rectangular can be larger than that of a tube body whose cross section is circular.

A high-frequency current (300 Hz to 10 kHz) is supplied to the energization coil from the high-frequency power source via the feeding terminals. The high-frequency current has such properties as to flow unevenly on the side of the material to be heated due to a skin effect. Therefore, in a case where the cross section on the side of the material to be heated is rectangular, an energization area is larger as compared with a case where the cross section is circular. Therefore, when a current density is lowered, the loss can be decreased, so that the efficiency can further be improved.

Additionally, in the energization coil, a cooling effect per unit flow rate of the cooling water increases due to the water flow path whose cross section is rectangular, and hence the energization coil is efficiently cooled while suppressing an amount of the cooling water.

Furthermore, a tube body material constituting the energization coil is copper, so that a high conductivity can be obtained. It is necessary that the cooling coil is non-magnetic and has a low conductivity and an excellent heat resistance, and hence the tube body material is suitably austenitic stainless steel.

### BRIEF DESCRIPTION OF DRAWINGS

FIG. 1 is an explanatory view schematically showing a high-frequency induction melting furnace of an embodiment of the present invention;

FIG. 2 is an explanatory view showing a main part of an energization coil and a cooling coil; and

FIG. 3 is a diagram showing comparison values of tube bodies of different sectional shapes which are to be employed for the energization coil.

### DESCRIPTION OF EMBODIMENTS

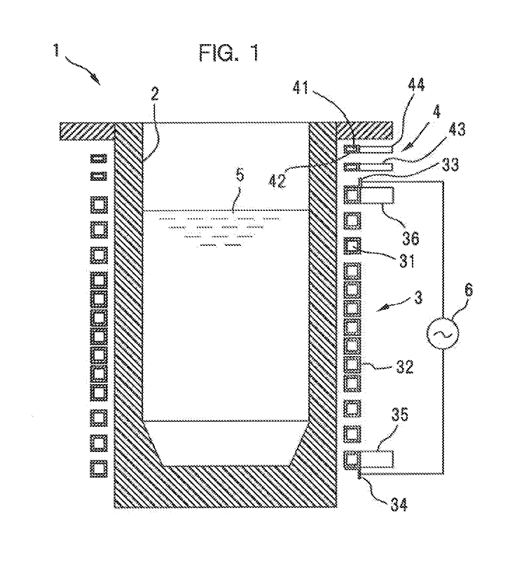

One embodiment of the present invention will be described with reference to the drawings. As shown in FIG. 1, a high-frequency induction melting furnace 1 of the present embodiment comprises a melting chamber 2 made of a refractory material, an energization coil 3 wound around an outer periphery of the melting chamber 2, and a cooling coil 4 wound around the outer periphery of the melting chamber 2 positioned above the energization coil 3. Reference numeral 5 is a molten metal, and is a material to be heated, for example, cast steel thrown into the melting chamber 2.

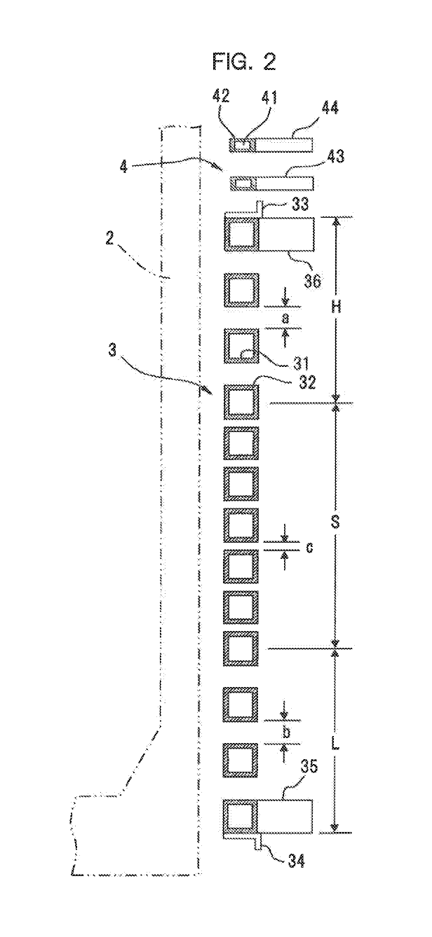

As shown in FIG. 2, the energization coil 3 is constituted of a longitudinal tube body 32 having therein a water flow path 31 through which cooling water flows. The tube body 32 constituting the energization coil 3 is formed by using copper having a high conductivity as a material, and the tube body is formed so that in a cross section perpendicular to an axial line of a longitudinal direction of the tube body, an outer peripheral shape and an inner peripheral shape which is the water flow path 31 are both rectangular.

An upper feeding terminal 33 is disposed at an upper end of a height direction of the energization coil 3 and a lower feeding terminal 34 is disposed at a lower end of the height direction of the energization coil 3. As shown in FIG. 1, both the feeding terminals 33, 34 are connected to a high-frequency power source 6.

Furthermore, as shown in FIG. 2, in the energization coil 3, each of a tube body space a of an upper end portion region H having the predetermined number of turns from the upper feeding terminal 33 (from the upside to the tube body 32 of the third turn in FIG. 2) and a tube body space b of a lower end portion region L having the predetermined number of turns from the lower feeding terminal 34 (from the downside to the tube body 32 of the third turn in FIG. 2) is larger than a tube body space c of a central portion region S positioned between the both end portion regions H and L.

Furthermore, at the lower end of the height direction on an upstream side of the water flow path 31 of the energization coil 3, a water supply terminal 35 communicating with the water flow path 31 is disposed, and at the upper end of the height direction on a downstream side of the water flow path 31 of the energization coil 3, a water discharge terminal 36 communicating with the water flow path 31 is disposed.

The cooling coil 4 is constituted of a longitudinal tube body 42 having therein a water flow path 41 through which the cooling water flows. The tube body 42 constituting the cooling coil 4 is formed by using, as a material, austenitic stainless steel which is non-magnetic and has a low conductivity and an excellent heat resistance, and has a smaller diameter than the tube body 32 of the energization coil 3.

Furthermore, the tube body 42 constituting the cooling coil 4 is formed so that in a cross section perpendicular to an axial line of a longitudinal direction of the tube body, an outer peripheral shape and an inner peripheral shape which is the water flow path 41 are both rectangular. Furthermore, at a lower end of the height direction on an upstream side of the water flow path 41 of the cooling coil 4, a water supply terminal 43 communicating with the water flow path 41 is disposed, and at an upper end of the height direction on a downstream side of the water flow path 41 of the cooling coil 4, a water discharge terminal 44 communicating with the water flow path 41 is disposed.

The cooling water is supplied to the water flow path 31 of the energization coil 3 from the water supply terminal 35 and the water discharge terminal 36 by a pump not illustrated, and the cooling water is supplied to the water flow path 41 of the cooling coil 4 from the water supply terminal 43 and the water discharge terminal 44 by a pump not illustrated, whereby independent passing water paths are formed by the energization coil 3 and the cooling coil 4.

In the high-frequency induction melting furnace 1 by the above constitution, the tube body space a of the upper end portion region H and the tube body space b of the lower end portion region L in the energization coil 3 are larger than the tube body space c of the central portion region S, so that eddy current losses in the upper end portion region H and the lower end portion region L can be decreased, and an efficiency can be improved.

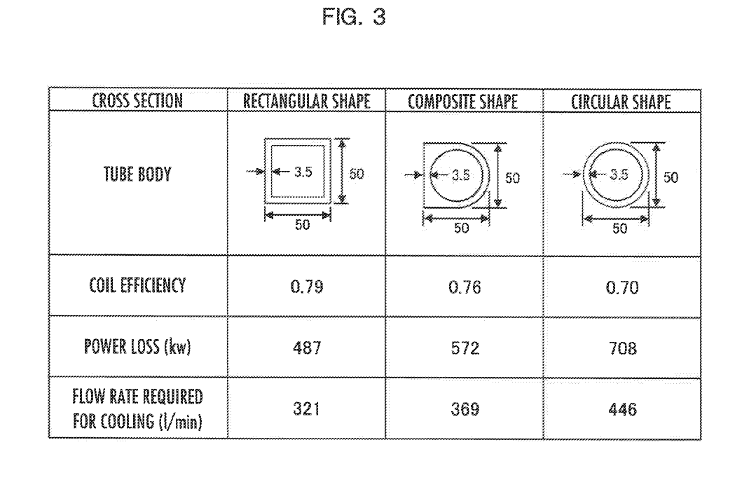

Furthermore, the energization coil 3 is formed by the tube body 32 whose cross section is rectangular, so that it is possible to obtain a higher electric efficiency as compared with a case where a tube body whose cross section is circular is used. To confirm this fact, as shown in FIG. 3, the present inventor compared efficiencies of tube bodies made of copper and having different sectional shapes, when the tube bodies had the same thickness of 3.5 mm, the same height direction dimension of 50 mm and the same width direction dimension of 50 mm. As a result, as shown in FIG. 3, it is possible to confirm that the tube body whose cross section is rectangular has a lower power loss and a higher coil efficiency, further may require a less flow rate of the cooling water for predetermined cooling and can obtain a higher cooling effect, as compared with the tube body whose cross section is circular.

Furthermore, the cooling coil 4 is formed of the tube body 42 by use of austenitic stainless steel as the material, so that it is possible not only to improve a cooling efficiency but also to decrease the eddy current loss while suppressing an influence of an induced current from the energization coil 3, so that the efficiency of the energization coil 3 is further improved.

### DESCRIPTION OF REFERENCE NUMERALS

1 . . . high-frequency induction melting furnace, 2 . . . melting chamber, 3 . . . energization coil, 4 . . . cooling coil, 5 . . . molten metal (a material to be heated), 6 . . . high-frequency power source, 31, 41 . . . water flow path, 32, 42 . . . tube body, and 33, 34 . . . feeding terminal

1. A high-frequency induction melting furnace comprising: an energization coil formed by winding a longitudinal tube body having therein a water flow path through which cooling water flows, around an outer periphery of a melting chamber, and including feeding terminals disposed at upper and lower ends of a height direction; and a cooling coil formed by winding another longitudinal tube body having therein a water flow path through which cooling water flows, around the outer periphery of the melting chamber which is positioned above the energization coil, to melt a material to be heated in the melting chamber by a power supplied from a high-frequency power source to the energization coil via the upper and lower feeding terminals,
wherein in the energization coil, a tube body space of an end portion region having a predetermined number of turns from each of the feeding terminals is larger than a tube body space of a central portion region positioned between both of the end portion regions, and a high-frequency current of 300 Hz to 10 kHz is supplied from the high-frequency power source to the energization coil via the feeding terminals,
the tube body constituting the energization coil is made of copper, and is formed so that in a cross section perpendicular to an axial line of a longitudinal direction along a total length of the tube body, an outer peripheral shape and an inner peripheral shape which is the water flow path are both rectangular and four sides have an equal thickness, and
the tube body constituting the cooling coil is made of austenitic stainless steel.
